(19) United States
(12) Patent Application Publication
(10) Pub. No.: US 2025/0351844 A1
(43) Pub. Date: Nov. 20, 2025

(54) MEANS AND METHODS FOR REDUCING PHOSPHORUS SECRETION BY FISH

(71) Applicants: DSM IP ASSETS B.V., HEERLEN (NL); NOVOZYMES A/S, Bagsvaerd (DK)

(72) Inventor: Ester SANTIGOSA CULI, Kaiseraugst (CH)

(21) Appl. No.: 18/871,339

(22) PCT Filed: Jun. 6, 2023
(86) PCT No.: PCT/EP2023/065102

§ 371 Date: Dec. 3, 2024

(30) Foreign Application Priority Data
Jun. 8, 2022 (EP) 22177706.3

(51) Int. Cl. A23K 10/14; A23K 20/189; A23K 20/26; A23K 50/80

(52) U.S. Cl. CPC A23K 10/14; A23K 20/189; A23K 20/26; A23K 50/80; C12Y 301/03008; C12Y 301/03026; C12Y 301/03072

(57) ABSTRACT

The present invention relates to a fish feed or fish feed additive comprising one or more polypeptides having a phytase activity, wherein said phytase activity comprising EC: 3.1.3.26 (i.e., 4-phytase) and/or EC 3.1.3.8 (i.e., 3-phytase) and/or EC 3.1.3.72 (i.e., 5-phytase) phytase activity, wherein said phytase activity is dosed at a level which is at least 10% less than a efficient (e.g., optimal) dose of phytase activity configured for maximum fish growth response. The present invention relates to a method for reducing phosphorus secretion and/or excretion by a fish, said method comprising: administering the animal feed or animal feed additive according to any one of preceding claims.

### FIELD OF THE INVENTION

The present invention relates to a fish feed or fish feed additive comprising one or more polypeptides having a phytase activity, wherein said phytase activity comprising EC: 3.1.3.26 (i.e., 4-phytase) and/or EC 3.1.3.8 (i.e., 3-phytase) and/or EC 3.1.3.72 (i.e., 5-phytase) phytase activity, wherein said phytase activity is dosed at a level which is at least 10% less than an efficient dose of phytase activity configured for maximum fish growth response/weight gain in order to significantly reduce phosphorus secretion and/or excretion by said fish. The present invention relates to a method for reducing phosphorus secretion and/or excretion by a fish, said method comprising: administering the animal feed or animal feed additive according to the present invention.

### BACKGROUND OF THE INVENTION

In animal feed, phosphorus can be found in e.g. cereals and pulses mainly in the form of phytate. However, monogastric animals such as pigs, poultry and fish are not capable of directly absorbing phytate or phytic acid. This results in the excretion of phytate resulting in phosphorus being discharged into waterways in regions with intensive livestock production. Furthermore, phytic acid binds to metals such as calcium, copper or zinc and has a negative effect on the metabolism of monogastric animals. In order to compensate for the phosphate deficit of these animals and to ensure sufficient growth and health, inorganic phosphate is added to the animal feed.

However, the addition of inorganic phosphate is costly and leads to further adverse effects on the environment. By using a phytase in animal feeds, the phytate is hydrolyzed to substrates which the animal can utilise. This can result in improved animal performance (e.g. improved FCR or BWG), a reduction of the phosphate burden on the environment and a reduced cost to the farmer. Thus phytases, are typically added to the diet of animals, and especially monogastric animals such as poultry and swine, and it is well known in the art that this can result in improved animal performance, such as improved body weight gain and/or feed conversion ratio (Selle & Ravindran, 2007, “Microbial phytase in poultry nutrition”, Anim. Feed Sci. Tech., 135:1-41 and Selle and Ravindran, 2008, “Phytate degrading enzymes in pig nutrition”, Livestock Sci., 1 13:99-122). However, even when phytase is added to animal feed for maximum growth response/weight gain, phosphorus excretion is still significant. Accordingly, there is still a need to reduce environmental burden of excreted phosphorus in animal feed.

The technical problem underlying the present application is thus to comply with this need. The technical problem is solved by providing the embodiments reflected in the claims, described in the description and illustrated in the examples and figures that follow.

### SUMMARY OF THE INVENTION

Accordingly, in one aspect the present invention relates to a fish feed or fish feed additive comprising one or more polypeptides having a phytase activity, wherein said phytase activity comprising EC: 3.1.3.26 (i.e., 4-phytase) and/or EC 3.1.3.8 (i.e., 3-phytase) and/or EC 3.1.3.72 (i.e., 5-phytase) phytase activity, wherein said phytase activity is dosed at a level which is at least 10% (e.g., at least 15%, at least 20%, at least 25%, at least 30% or at least 35%) less than a maximum dose of phytase activity for maximum fish growth response/weight gain.

In another aspect the present invention relates to a method for reducing phosphorus secretion and/or excretion by a fish, preferably said phosphorus is in the form of a phosphate (e.g., phosphate anion [PO₄]³⁻), said method comprising: administering the animal feed or animal feed additive according to the present invention.

### BRIEF DESCRIPTION OF THE FIGURES

FIG. 1: Daily soluble phosphorus excretion in fish fed the various experimental diets. Bars are means±standard deviation (n=4). Different superscripts, denote a statistical difference (P<0.05).

### DETAILED DESCRIPTION OF THE INVENTION

As used herein, the term “animal” may refer to any animal except humans. Examples of animals are non-ruminants and ruminants. Ruminant animals include, for example, animals such as sheep, goats, cattle, e.g. beef cattle, cows, and young calves, deer, yank, camel, llama and kangaroo. Non-ruminant animals include monogastric animals, including but not limited to pigs or swine (including, but not limited to, piglets, growing pigs, and sows); poultry such as turkeys, ducks, quail, guinea fowl, geese, pigeons (including squabs) and chicken (including but not limited to broiler chickens (referred to herein as broiles), chicks, layer hens (referred to herein as layers)); horses (including but not limited to hotbloods, coldbloods and warm bloods) crustaceans (including but not limited to shrimps and prawns) and fish including but not limited to amberjack, arapaima, barb, bass, bluefish, bocachico, bream, bullhead, cachama, carp, catfish, catla, chanos, char, cichlid, cobia, cod, crappie, dorada, drum, eel, goby, goldfish, gourami, grouper, guapote, halibut, java, labeo, lai, loach, mackerel, milkfish, mojarra, mudfish, mullet, paco, pearlspot, pejerrey, perch, pike, pompano, roach, salmon, sampa, sauger, sea bass, seabream, shiner, sleeper, snakehead, snapper, snook, sole, spinefoot, sturgeon, sunfish, sweetfish, tench, terror, tilapia, trout, tuna, turbot, vendace, walleye and whitefish.

As used herein, the term “animal feed” (e.g., fish feed) may refer to any compound, preparation, or mixture suitable for, or intended for intake by an animal (e.g., a fish). Animal feed for a monogastric animal typically comprises concentrates as well as vitamins, minerals, enzymes, direct fed microbial, amino acids and/or other feed ingredients (such as in a premix) whereas animal feed for ruminants generally comprises forage (including roughage and silage) and may further comprise concentrates as well as vitamins, minerals, enzymes direct fed microbial, amino acid and/or other feed ingredients (such as in a premix). An animal feed additive (e.g., fish feed additive) is a formulated enzyme product which may further comprise e.g. vitamins, minerals, enzymes, amino acids, preservatives and/or antibiotics; i.e. a premix. The animal feed additive/premix is typically mixed in a feed mill with concentrates and/or forage such as vegetable protein, legumes or other plant material. The animal feed is typically fed as a pelleted feed to mono-gastric animals.

As used herein, the term “phytases” may refer to enzymes (also known as myo-inositol hexakisphosphate phosphohydrolases, e.g., EC: 3.1.3.26 (i.e., 4-phytases) or EC 3.1.3.8 (i.e., 3-phytases) or EC 3.1.3.72 (i.e., 5-phytases)) that hydrolyze phytate (myo-inositol hexakisphosphate) to myo-inositol and inorganic phosphate and are known to be valuable feed additives.

A variety of Phytases differing in pH optima, substrate specificity, and specificity of hydrolysis have been identified in plants and fungi. Acid Phytases from wheat bran and Aspergilli have been extensively studied and the stereo specificity of hydrolysis has been well established. Based on the specificity of initial hydrolysis, two classes of acid Phytases are recognized by the International Union of Pure and Applied Chemistry and the International Union of Biochemistry (IUPAC-IUB, 1975), the 6-Phytase, found for example in plants, and the 3-Phytase, found in fungi. The 6-Phytase hydrolyses the phosphate ester at the L-6 (or D-4) position of phytic acid, and the 3-Phytase hydrolyses the phosphate ester at the D-3 position.

The ENZYME site at the internet (http://www.expasy.ch/enzyme/) is a repository of information relative to the nomenclature of enzymes. It is primarily based on the recommendations of the Nomenclature Committee of the International Union of Biochemistry and Molecular Biology (IUB-MB) and it describes each type of characterized enzyme for which an EC (Enzyme Commission) number has been provided (Bairoch A. The ENZYME database, 2000, Nucleic Acids Res 28:304-305). See also the handbook Enzyme Nomenclature from NC-IUBMB, 1992).

According to the ENZYME site, three different types of phytases are known: A so-called 3-phytase (myo-inositol hexaphosphate 3-phosphohydrolase, EC 3.1.3.8), a so-called 6-phytase (myo-inositol hexaphosphate 6-phosphohydrolase, EC 3.1.3.26) and a so-called 5-phytase (myo-inositol hexaphosphate 5-phosphohydrolase, EC 3.1.3.72). For the purposes of the present invention, all three types are included in the definition of phytase.

Examples of Phytases for use according to the present inventions include but are not limited to Phytases derived from strains of E. coli, from strains of Buttiauxella, Ascomycete Phytases as disclosed in EP 684313 (for example derived from strains of Aspergillus fumigatus, Aspergillus terreus, and Myceliophthora thermophila); JP 11000164 (a Phytase derived from a strain of Penicillium.); U.S. Pat. No. 6,139,902 (a Phytase derived from a strain of Aspergillus), WO 98/13480 (Monascus anka Phytase), WO 2008/116878 and WO 2010/034835 (Hafnia phytase). A preferred phytase for use according to the invention is derived from the family Enterobacteriaceae, and more preferably is a species of Escherichia, Citrobacter, Buttiauxella or Hafnia.

For purposes of the present invention, preferred phytases are the phytases contained in the following commercial products: Ronozyme®HiPhos, Ronozyme®NP and Ronozyme® P (DSM Nutritional Products AG), Natuphos™ (BASF), Finase® and Quantum® Blue (AB Enzymes), OptiPhos® (Huvepharma) Phyzyme® XP (Verenium/DuPont) and Axtra® PHY (DuPont).

For the purpose of the present invention, phytase activity is determined by the liberation of inorganic phosphate from Na-phytate solution, wherein one phytase activity unit is the amount of enzyme which liberates 1 μmol inorganic phosphate per min from a 0.0051 M Na-phytate solution in 0.25 M Na-acetate, pH 5.5 and at 37° C. (Engelen, A. J., et al., 1994, “Simple and rapid determination of phytase activity”, J. AOAC Int. 77:760-764). Examples of activity unit names are: FYT, FTU and U. Phytase activity may be determined using the assay as described in Example 1 of US2017119017 (“Determination of phytase activity”).

Specific activity is measured on highly purified samples (an SDS poly acryl amide gel should show the presence of only one component). The enzyme protein concentration may be determined by amino acid analysis, and the phytase activity in the units of FYT. Specific activity is a characteristic of the specific phytase variant in question, and it is calculated as the phytase activity measured in FYT units per mg phytase enzyme protein.

For determining mg Phytase protein per kg feed or feed additive, the enzyme is purified from the feed composition or the feed additive, and the specific activity of the purified enzyme is determined using a relevant assay. The Phytase activity of the feed composition or the feed additive is also determined using the same assay, and on the basis of these two determinations, the dosage in mg Phytase protein per kg feed is calculated.

In one embodiment, the present invention provides a fish feed or fish feed additive comprising one or more polypeptides having a phytase activity, wherein said phytase activity comprising EC: 3.1.3.26 (i.e., 4-phytase) and/or EC 3.1.3.8 (i.e., 3-phytase) and/or EC 3.1.3.72 (i.e., 5-phytase) phytase activity, wherein said phytase activity is dosed at a level which is at least 10% (e.g., at least 15%, at least 20%, at least 25%, at least 30%, at least 35%, least 40%, least 45%, least 50%, least 55%, least 60%, least 65%, least 70%, least 75%, least 80%) less than a maximum (or optimal) dose (e.g., standard commercial dose for that phytase) of phytase activity calculated for maximizing fish growth response (e.g., maximal phytase activity calculated for achieving maximal fish growth response/weight gain in given conditions), preferably wherein said phytase activity is dosed at a level from about 500 (e.g., corresponding to “PHY500” diet as shown in Example 1 herein) to about or less than 2000 (e.g., corresponding to “PHY2000” diet as shown in Example 1 herein) phytase activity units (FYT) per kg fish feed, further preferably wherein said phytase activity is dosed at a level from about 500 (e.g., corresponding to “PHY500” diet as shown in Example 1 herein) to about or less than 1000 (e.g., corresponding to “PHY1000” diet as shown in Example 1 herein) phytase activity units (FYT) per kg fish feed.

In another embodiment, the present invention provides a method for reducing phosphorus secretion and/or excretion by a fish, preferably said phosphorus is in the form of a phosphate (e.g., phosphate anion [PO₄]³⁻), said method comprising: administering the animal feed or animal feed additive according to the present invention.

In yet another embodiment, the phytase is applied/present in fish feed/method at a concentration at least 10% (e.g., at least 15%, at least 20%, at least 25%, at least 30% or at least 35%, least 40%, least 45%, least 50%, least 55%, least 60%, least 65%) less than standard commercial dose for that phytase.

In yet another embodiment, the phytase activity is dosed at a level of about 500 (e.g., corresponding to “PHY500” diet as shown in Example 1 herein), about or less than 1000 (e.g., corresponding to “PHY1000” diet as shown in Example 1 herein) or about or less than 2000 (e.g., corresponding to “PHY2000” diet as shown in Example 1 herein) phytase activity units (FYT) per kg fish feed.

In yet another embodiment, the phytase is administered in such amounts that the specific activity in said final fish feed is between about 500 FYT/kg feed and about 2000 FYT/kg feed (e.g., 500, 1000 or 2000 FYT/kg feed), preferably is between about 500 FYT/kg feed and about or less than 1000 FYT/kg feed.

### ITEMS OF THE INVENTION

The present invention may also be summarized by the following items:

1. A fish feed or fish feed additive comprising one or more polypeptides having a phytase activity, wherein said phytase activity comprising EC: 3.1.3.26 (i.e., 4-phytase) and/or EC 3.1.3.8 (i.e., 3-phytase) and/or EC 3.1.3.72 (i.e., 5-phytase) phytase activity, wherein said phytase activity is dosed at a level which is at least 10% (e.g., at least 15%, at least 20%, at least 25%, at least 30%, at least 35%, least 40%, least 45%, least 50%, least 55%, least 60%, least 65%, least 70%, least 75%, least 80%) less than a maximum (or optimal) dose (e.g., standard commercial dose for that phytase) of phytase activity calculated for maximizing fish growth response (e.g., maximal phytase activity calculated for achieving maximal fish growth response/weight gain in given conditions), preferably wherein said phytase activity is dosed at a level from about 500 (e.g., corresponding to “PHY500” diet as shown in Example 1 herein) to about or less than 2000 (e.g., corresponding to “PHY2000” diet as shown in Example 1 herein) phytase activity units (FYT) per kg fish feed, further preferably wherein said phytase activity is dosed at a level from about 500 (e.g., corresponding to “PHY500” diet as shown in Example 1 herein) to about or less than 1000 (e.g., corresponding to “PHY1000” diet as shown in Example 1 herein) phytase activity units (FYT) per kg fish feed.

2. The fish feed or fish feed additive of any one of preceding items, wherein said fish feed or fish feed additive comprises phytate-bound phosphorus.

3. The fish feed or fish feed additive of any one of preceding items, wherein said fish feed or fish feed additive does not comprise inorganic P (Pi) additives, preferably said fish feed or fish feed additive does not comprise inorganic P (Pi) additives such as DCP (dicalcium phosphate) and/or MCP (monocalcium phosphate) and/or PP (potassium phosphate), and/or MSP (monosodium phosphate), most preferably said fish feed or fish feed additive does not comprise inorganic P (Pi) additives such as DCP (dicalcium phosphate) and MCP (monocalcium phosphate).

4. The fish feed or fish feed additive of any one of preceding items, wherein said phytase activity is dosed at a level of about 500 (e.g., corresponding to “PHY500” diet as shown in Example 1 herein), about or less than 1000 (e.g., corresponding to “PHY1000” diet as shown in Example 1 herein) or about or less than 2000 (e.g., corresponding to “PHY2000” diet as shown in Example 1 herein) phytase activity units (FYT) per kg fish feed.

5. The fish feed or fish feed additive of any one of preceding items, wherein one phytase activity unit is the amount of enzyme which liberates 1 μmol inorganic phosphate per minute from a 0.0051 M Na-phytate solution in 0.25 M Na-acetate at pH 5.5 and at 37° C.

6. The fish feed or fish feed additive of any one of preceding items, wherein said one or more polypeptides having a phytase activity are derived from a bacterial source, preferably said bacterial source is Citrobacter braakii bacteria, further preferably said one or more polypeptides are “RONOZYME HiPhos” phytases (e.g., and/or other suitable phytases as disclosed in WO2017001701) or having UniProtKB Accession Number: Q2VY22-1.

7. A method for reducing phosphorus secretion and/or excretion by a fish, preferably said phosphorus is in the form of a phosphate (e.g., phosphate anion [PO₄]³⁻), said method comprising: administering the animal feed or animal feed additive according to any one of preceding items.

8. The method of any one of preceding items, wherein said phytase is administered in such amounts that the specific activity in said final fish feed is between about 500 FYT/kg feed and about 2000 FYT/kg feed (e.g., 500, 1000 or 2000 FYT/kg feed), preferably is between about 500 FYT/kg feed and about or less than 1000 FYT/kg feed.

9. The method of any one of preceding items, wherein said phosphorus secretion and/or excretion is reduced by at least 5% (e.g., at least 10%, at least 15%, at least 20%, at least 25%, at least 30% or at least 35%).

10. The method of any one of preceding items, wherein said method is also a method of decreasing weight gain by fish in order to reduce phosphorus secretion and/or excretion by said fish.

11. The method of any one of preceding items, wherein said method is ex vivo method.

12. The method of any one of preceding items, wherein said phosphorus secretion and/or excretion is post-prandial soluble phosphorus secretion and/or excretion.

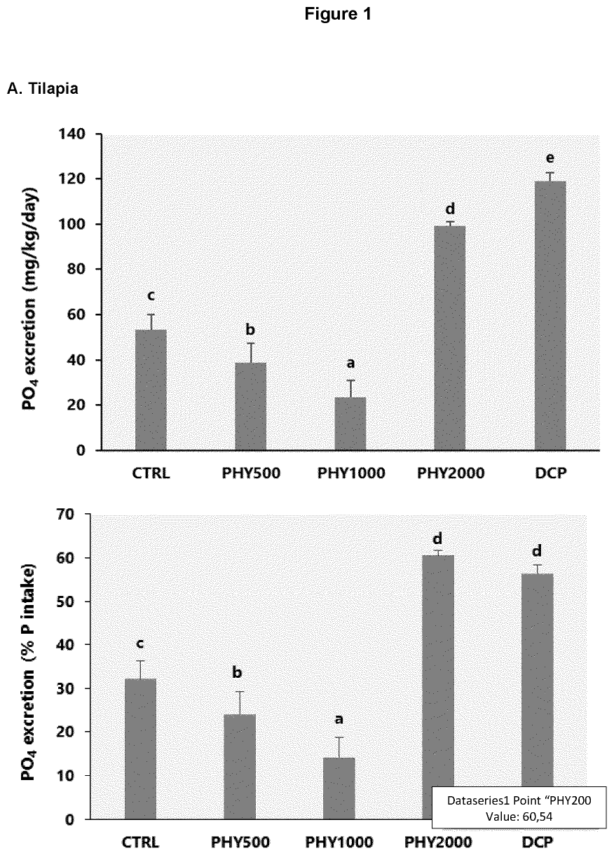

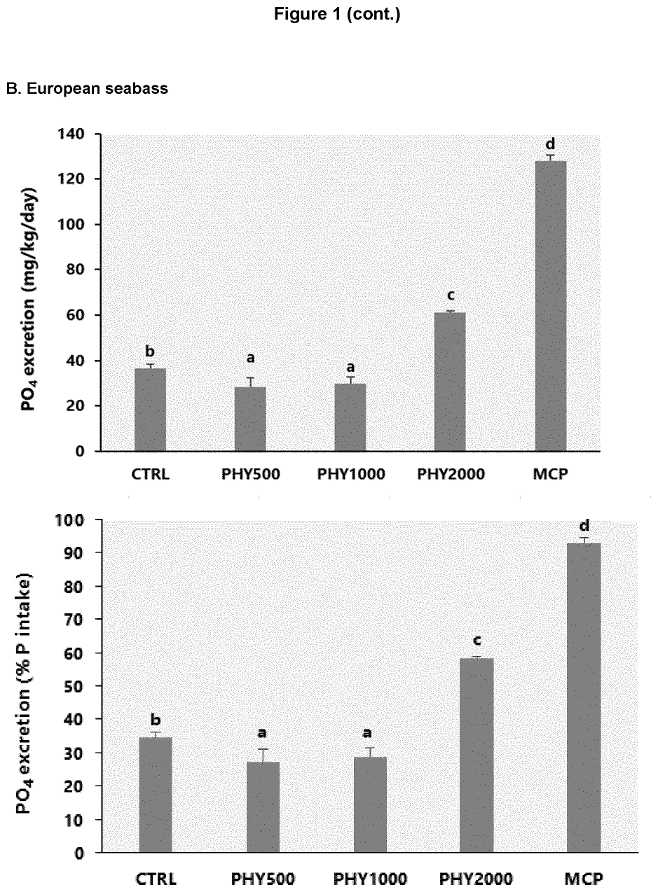

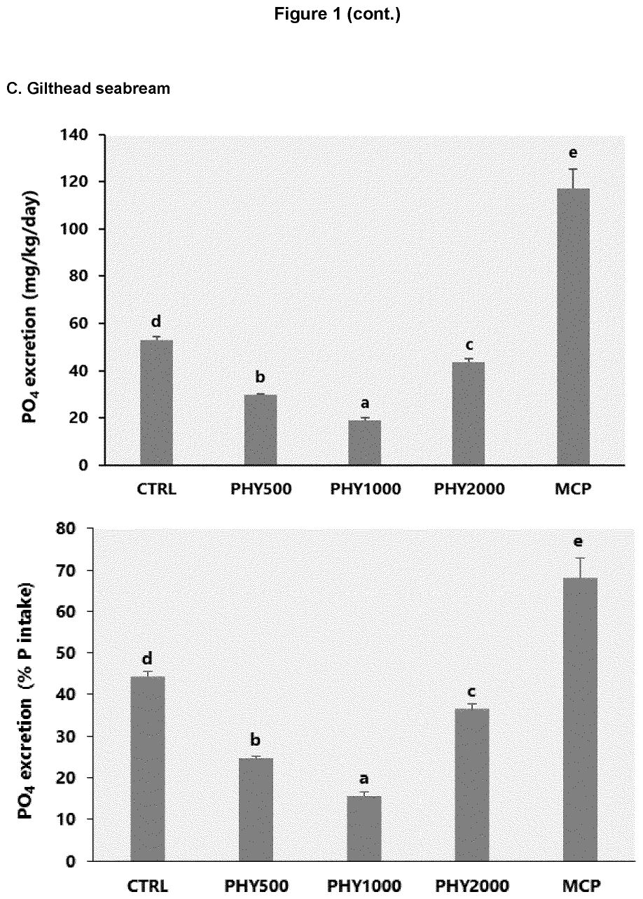

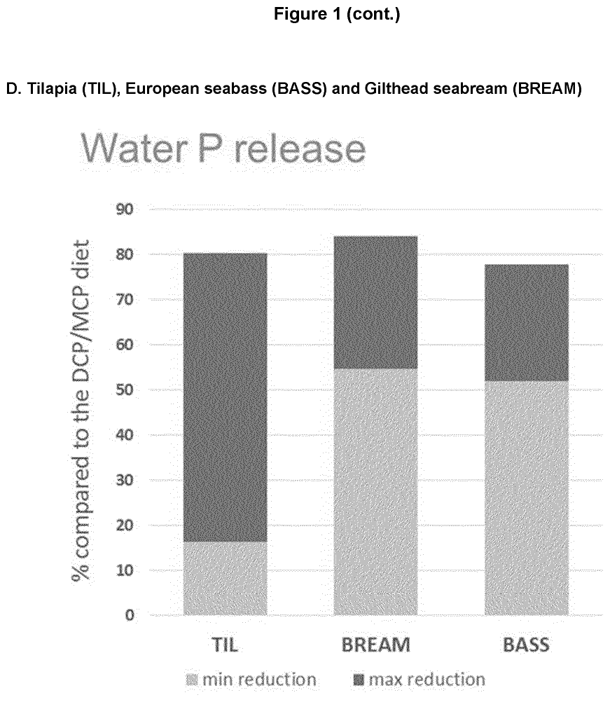

13. The method of any one of preceding items, wherein said phosphorus is a soluble phosphorus, preferably said soluble phosphorus is cumulative soluble phosphorus secretion and/or excretion (e.g., 24 hours post-prandial cumulative soluble phosphorus excretion, e.g., as described in Example 1 and/or FIG. 1 herein).

14. Use of the fish feed or fish feed additive of any one of proceeding items for reducing phosphorus secretion and/or excretion by a fish.

15. The fish feed, fish feed additive, method or use of any one of preceding items, wherein said fish is selected from the group consisting of genera: Tilapia (e.g., Tilapia sparrmanii or banded tilapia), Oreochromis (e.g., Oreochromis niloticus or Nile tilapia), Dicentrarchus (e.g., Dicentrarchus labrax or European seabass) and Sparus (e.g., Sparus aurata or gilthead Seabream).

16. The fish feed, fish feed additive, method or use of any one of preceding items, wherein:
a) when said phytase activity is dosed at a level about 500 (e.g., corresponding to “PHY500” diet as shown in Example 1 herein) to about 1000 (e.g., corresponding to “PHY1000” diet as shown in Example 1 herein) phytase activity units (FYT) per kg fish feed, the fish is selected from genera Oreochromis or Dicentrarchus (e.g., Oreochromis niloticus or Dicentrarchus labrax); or
b) when said phytase activity is dosed at a level about 500 (e.g., corresponding to “PHY500” diet as shown in Example 1 herein) to about 2000 (e.g., corresponding to “PHY1000” diet as shown in Example 1 herein) phytase activity units (FYT) per kg fish feed, the fish is selected from genera Oreochromis, Sparus and Dicentrarchus (e.g., Oreochromis niloticus, Dicentrarchus labrax or Sparus aurata).

17. The fish feed, fish feed additive, method or use of any one of preceding items, wherein said fish feed, fish feed additive is an aquaculture feed or feed additive.

18. The fish feed, fish feed additive, method or use of any one of preceding items, wherein said phytase is administered/present in such amounts that the specific activity in said final fish feed is between about 500 FYT/kg feed and about 2000 FYT/kg feed (e.g., 500, 1000 or 2000 FYT/kg feed), preferably between about 500 FYT/kg feed and about 1000 FYT/kg feed.

Unless otherwise stated, the following terms used in this document, including the description and claims, have the definitions given below.

Those skilled in the art will recognize, or be able to ascertain, using not more than routine experimentation, many equivalents to the specific embodiments of the invention described herein. Such equivalents are intended to be encompassed by the present invention.

It is to be noted that as used herein, the singular forms “a”, “an”, and “the”, include plural references unless the context clearly indicates otherwise. Thus, for example, reference to “a reagent” includes one or more of such different reagents and reference to “the method” includes reference to equivalent steps and methods known to those of ordinary skill in the art that could be modified or substituted for the methods described herein.

Unless otherwise indicated, the term “at least” preceding a series of elements is to be understood to refer to every element in the series. Those skilled in the art will recognize or be able to ascertain using no more than routine experimentation, many equivalents to the specific embodiments of the invention described herein. Such equivalents are intended to be encompassed by the present invention.

The term “and/or” wherever used herein includes the meaning of “and”, “or” and “all or any other combination of the elements connected by said term”.

The term “about” or “approximately” as used herein means within 20%, preferably within 10%, and more preferably within 5% of a given value or range. It includes, however, also the concrete number, e.g., about 20 includes 20.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein the term “comprising” can be substituted with the term “containing” or “including” or sometimes when used herein with the term “having”.

When used herein “consisting of” excludes any element, step, or ingredient not specified in the claim element. When used herein, “consisting essentially of” does not exclude materials or steps that do not materially affect the basic and novel characteristics of the claim.

In each instance herein any of the terms “comprising”, “consisting essentially of” and “consisting of” may be replaced with either of the other two terms.

It should be understood that this invention is not limited to the particular methodology, protocols, material, reagents, and substances, etc., described herein and as such can vary. The terminology used herein is for the purpose of describing particular embodiments only, and is not intended to limit the scope of the present invention, which is defined solely by the claims.

All publications cited throughout the text of this specification (including all patents, patent applications, scientific publications, manufacturer's specifications, instructions, etc.) are hereby incorporated by reference in their entirety. Nothing herein is to be construed as an admission that the invention is not entitled to antedate such disclosure by virtue of prior invention. To the extent the material incorporated by reference contradicts or is inconsistent with this specification, the specification will supersede any such material.

### EXAMPLES

The following examples illustrate the invention. These examples should not be construed as to limit the scope of this invention. The examples are included for purposes of illustration and the present invention is limited only by the claims.

### Example 1: Post-Prandial Soluble Phosphorus Excretion

At the end of the growth performance trials and subsequently to all associated samplings, post-prandial total soluble phosphorus excretion was measured, during three non-consecutive days, by a standardized collection of water from the rearing tanks. To reduce the basal phosphorus levels in the rearing system, a complete replacement of the rearing water was made prior to measurements. Moreover, to avoid any potential daily carry over effects, measurements of phosphorus excretion were made under aerated static water conditions. On measurement days, fish were fed a fixed ration, corresponding to the minimum feed intake recorded during the growth study (1.6% of biomass for Nile tilapia and 1.4% of biomass for European seabass and gilthead seabream). One tank with no fish was used as control. Samples of water from each tank were collected continuously during 23 h after the meal, using multi-channel peristaltic pumps (Minipuls® 3, Gilson, Middleton, WI, USA) into 2 L glass flasks kept in ice. After each daily cycle, the refrigerated water samples were immediately sent for analysis of total phosphate (PO₄) by an external laboratory (Eurofins Food Testing Lisboa, Portugal). Based on a fixed water flow rate (4.5 L/min in tilapia and 5.6 L/min in European seabass and gilthead seabream) and the fish biomass per tank, the 24 hours cumulative soluble phosphorus excretion was estimated (FIG. 1, Tables 1-6, wherein phytase activity (RONOZYME HiPhos is dosed at a level 500 (e.g., corresponding to “PHY500” diet, 1000 (e.g., corresponding to “PHY1000” diet) and 2000 (e.g., corresponding to “PHY2000” diet) phytase activity units (FYT) per kg fish feed using “DSM Phytases Matrix Calculator” available at https://phytases.dsm.com).

TABLE 1
P-Excretion (mg/kg/day) in the Nile tilapia feeding trial:

| | mg/kg/day | |
|---|---|---|
| Diet | P excretion | STD |
| CTRL | 53.21 | 6.88 |
| PHY500 | 38.69 | 8.68 |
| PHY1000 | 23.37 | 7.41 |
| PHY2000 | 99.24 | 1.69 |
| DCP | 118.82 | 3.87 |

TABLE 2
P-Excretion (% intake) in the Nile tilapia feeding trial:

| | % intake | |
|---|---|---|
| Diet | P excretion | STD |
| CTRL | 32.13 | 4.15 |
| PHY500 | 23.85 | 5.35 |
| PHY1000 | 14.17 | 4.49 |
| PHY2000 | 60.54 | 1.03 |
| DCP | 56.44 | 1.84 |

TABLE 3
P-Excretion (mg/kg/day) in the European seabass feeding trial:

| | mg/kg/day | |
|---|---|---|
| Diet | P excretion | STD |
| CTRL | 36.34 | 1.85 |
| PHY500 | 28.46 | 4.07 |
| PHY1000 | 29.74 | 2.89 |
| PHY2000 | 61.27 | 0.47 |
| MCP | 127.81 | 2.59 |

TABLE 4
P-Excretion (% intake) in the European seabass feeding trial:

| | % intake | |
|---|---|---|
| Diet | P excretion | STD |
| CTRL | 34.42 | 1.75 |
| PHY500 | 27.29 | 3.90 |
| PHY1000 | 28.70 | 2.79 |
| PHY2000 | 58.35 | 0.44 |
| MCP | 92.73 | 1.88 |

TABLE 5
P-Excretion (mg/kg/day) in the gilthead Seabream feeding trial:

| | mg/kg/day | |
|---|---|---|
| Diet | P excretion | STD |
| CTRL | 53.03 | 1.37 |
| PHY500 | 29.61 | 0.35 |
| PHY1000 | 18.86 | 1.05 |
| PHY2000 | 43.45 | 1.47 |
| MCP | 117.09 | 8.15 |

TABLE 6
P-Excretion (% intake) in the gilthead Seabream feeding trial:

| | % intake | |
|---|---|---|
| Diet | P excretion | STD |
| CTRL | 44.28 | 1.14 |
| PHY500 | 24.68 | 0.29 |
| PHY1000 | 15.60 | 0.87 |
| PHY2000 | 36.38 | 1.23 |
| MCP | 68.06 | 4.74 |

Conclusion: Fish fed the PHY500, PHY1000 diets for tilapia and European seabass, and also the PHY2000 diet in the case of seabream showed a significantly lower soluble P excretion than those fed the CTRL and DCP/MCP supplemented diets (P<0.05). Additionally, diets supplemented with DCP (tilapia) and MCP (seabass and seabream) showed a significantly higher soluble P excretion than those fed all other diets (P<0.05).

1. A fish feed or fish feed additive comprising one or more polypeptides having a phytase activity, wherein said phytase activity comprising EC: 3.1.3.26 (i.e., 4-phytase) and/or EC 3.1.3.8 (i.e., 3-phytase) and/or EC 3.1.3.72 (i.e., 5-phytase) phytase activity, wherein said phytase activity is dosed at a level which is at least 10% (e.g., at least 15%, at least 20%, at least 25%, at least 30% or at least 35%) less than an efficient dose of phytase activity for maximizing fish growth response and/or weight gain, preferably wherein said phytase activity is dosed at a level about 500 (e.g., corresponding to “PHY500” diet as shown in Example 1 herein) to about 2000 (e.g., corresponding to “PHY2000” diet as shown in Example 1 herein) phytase activity units (FYT) per kg fish feed, further preferably wherein said phytase activity is dosed at a level about 500 (e.g., corresponding to “PHY500” diet as shown in Example 1 herein) to about 1000 (e.g., corresponding to “PHY1000” diet as shown in Example 1 herein) phytase activity units (FYT) per kg fish feed.

2. The fish feed or fish feed additive of claim 1, wherein said fish feed or fish feed additive comprises phytate-bound phosphorus.

3. The fish feed or fish feed additive of claim 1, wherein said fish feed or fish feed additive does not comprise inorganic P (Pi) additives, preferably said fish feed or fish feed additive does not comprise inorganic P (Pi) additives such as DCP (dicalcium phosphate) and/or MCP (monocalcium phosphate) and/or PP (potassium phosphate), and/or MSP (monosodium phosphate), most preferably said fish feed or fish feed additive does not comprise inorganic P (Pi) additives such as DCP (dicalcium phosphate) and MCP (monocalcium phosphate).

4. The fish feed or fish feed additive of claim 1, wherein said phytase activity is dosed at a level of about 500 (e.g., corresponding to “PHY500” diet as shown in Example 1 herein), about 1000 (e.g., corresponding to “PHY1000” diet as shown in Example 1 herein) or about 2000 (e.g., corresponding to “PHY2000” diet as shown in Example 1 herein) phytase activity units (FYT) per kg fish feed.

5. The fish feed or fish feed additive of claim 1, wherein one phytase activity unit is the amount of enzyme which liberates 1 μmol inorganic phosphate per minute from a 0.0051 M Na-phytate solution in 0.25 M Na-acetate at pH 5.5 and at 37° C.

6. The fish feed or fish feed additive of claim 1, wherein said one or more polypeptides having a phytase activity are derived from a bacterial source, preferably said bacterial source is Citrobacter braakii bacteria.

7. A method for reducing phosphorus secretion and/or excretion by a fish, preferably said phosphorus is in the form of a phosphate (e.g., phosphate anion [PO₄]³⁻), said method comprising: administering the animal feed or animal feed additive according to claim 1.

8. The method of claim 1, wherein said phosphorus secretion and/or excretion is reduced by at least 5% (e.g., at least 10%, at least 15%, at least 20%, at least 25%, at least 30% or at least 35%).

9. The method of claim 1, wherein said phosphorus secretion and/or excretion is post-prandial soluble phosphorus secretion and/or excretion.

10. The method of claim 1, wherein said phosphorus is a soluble phosphorus, preferably said soluble phosphorus is cumulative soluble phosphorus secretion and/or excretion (e.g., 24 hours post-prandial cumulative soluble phosphorus excretion, e.g., as described in Example 1 and/or FIG. 1 herein).

11. Use of the fish feed or fish feed additive of claim 1 for reducing phosphorus secretion and/or excretion by a fish.

12. The fish feed, fish feed additive, method or use of claim 1, wherein said fish is selected from the group consisting of genera: Tilapia (e.g., Tilapia sparrmanii or banded tilapia), Oreochromis (e.g., Oreochromis niloticus or Nile tilapia), Dicentrarchus (e.g., Dicentrarchus labrax or European seabass) and Sparus (e.g., Sparus aurata or gilthead Seabream).

13. The fish feed, fish feed additive, method or use of claim 1, wherein:
a) when said phytase activity is dosed at a level about 500 (e.g., corresponding to “PHY500” diet as shown in Example 1 herein) to about 1000 (e.g., corresponding to “PHY1000” diet as shown in Example 1 herein) phytase activity units (FYT) per kg fish feed, the fish is selected from genera Oreochromis or Dicentrarchus (e.g., Oreochromis niloticus or Dicentrarchus labrax); or
b) when said phytase activity is dosed at a level about 500 (e.g., corresponding to “PHY500” diet as shown in Example 1 herein) to about 2000 (e.g., corresponding to “PHY1000” diet as shown in Example 1 herein) phytase activity units (FYT) per kg fish feed, the fish is selected from genera Oreochromis, Sparus and Dicentrarchus (e.g., Oreochromis niloticus, Dicentrarchus labrax or Sparus aurata).
